(19) United States
(12) Patent Application Publication
(10) Pub. No.: US 2009/0217606 A1
(43) Pub. Date: Sep. 3, 2009

(54) JOINING PANELS OF SHEET MATERIAL

(75) Inventor: Pasquale Daimiano Ciccone, Essendon (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: LYNX DEVELOP AND CONSULT PTY LTD, Essendon, Victoria (AU)

(21) Appl. No.: 12/064,615

(22) PCT Filed: Aug. 23, 2006
(86) PCT No.: PCT/AU2006/001219

§ 371 Date: Aug. 7, 2008

(30) Foreign Application Priority Data
Aug. 23, 2005 (AU) 2005904557

(51) Int. Cl. E04B 2/34; B23P 11/00; E04B 1/68; E04B 9/04

(52) U.S. Cl. 52/281; 29/525.01

(57) ABSTRACT

A system (10) for joining adjacent edges (12, 14) of respective panels (16, 18) of sheet material is provided. The system includes a first component (26) adapted to be positioned over the front of the adjacent edges and a second component (28) adapted to be positioned behind the adjacent edges. The second component (28) has a recess (38) capable of receiving at least a portion of the first component (26). A fastening device (30) for clamping the first and second components (26, 28) together is provided. The first and second components are clamped together in a manner that deforms the adjacent edges (12, 14) into the recess (38), whilst simultaneously forming a depression (48) at the front of the adjacent edges able to be filled with a compatible material (52) to conceal the adjacent edges (12, 14).

### FIELD OF THE INVENTION

The present invention relates to a system and method for joining adjacent edges of respective panels of sheet material. The system and method may find particular application for the joining of plaster boards for ceilings and walls.

### BACKGROUND OF THE INVENTION

There are various techniques for joining together adjacent panels of sheet material. The most common joining system uses tongue-in-groove joints, where one panel has a tongue projecting from its edge and an adjacent panel has a groove extending along its edge. The tongue is inserted into the groove. Adhesive may be used to secure the panels together. Additional fasteners, such as nails or screws, may then be used to further assure the assembly.

When using plaster boards to create a ceiling or wall, the plaster boards are provided in standard lengths and widths. The plaster board lengths are provided with a recessed edge at each side of the plaster board. When two panels are joined together, to form what is referred to as a recessed edge join, approved fillers can be applied for a smooth, even join, along the longitudinal edges of the boards. The join is generally not visible once the wall or ceiling is finished.

However, the ends of the plaster board lengths do not have recessed edges. This is due to the plaster board length needing to be cut to size to suit the particular application. Currently, the lateral edges of the two adjacent plaster boards are joined as a butt joint. This is where the two square-cut edges simply abut with adhesive between them. The join is then finished off in the standard way, with tape and plaster filler. As there is no positive engagement between the two plaster board lengths, additional material is required over the join to maintain integrity and conceal the join. Unfortunately, this additional material results in the join being visible, even after the wall or ceiling is finished. As there is no positive engagement, the two panels may drop out of alignment with each other, making the join visible.

Whilst a suitable solution would be to provide a recessed edge join across the lateral edges, this is not practical, as then the plaster board lengths could not be cut to size. This would require the plaster board manufacturer to provide the plaster boards in a variety of lengths. This would greatly increase the cost of plaster boards.

U.S. Pat. Nos. 1,967,846, 5,657,599, 5,799,458 and 6,108,990 have attempted to provide improved systems of joining panels of sheet material. These systems have a component that extends along the rear of the join and has a recess aligned with the join. A separate line of fasteners for each sheet is used to deform the respective sheets into the recess, leaving a depression on the front of the join that can be filled with suitable filler material.

It is an object of the present invention to provide an improved method and system for joining adjacent edges of respective panels of sheet material.

### SUMMARY OF THE INVENTION

According to a first aspect of the invention, there is provided a system for joining adjacent edges of respective panels of sheet material, the system including:
a first component adapted to be positioned over the front of the adjacent edges;
a second component adapted to be positioned behind the adjacent edges, the second component having a recess capable of receiving at least a portion of the first component; and
fastening means for clamping the first and second components together in a manner that deforms the adjacent edges into the recess, whilst simultaneously forming a depression at the front of the adjacent edges able to be filled with a compatible material to conceal the adjacent edges.

Preferably, the fastening means is a nail or screw. However, it will be appreciated that any suitable fastening means may be used. Alternatively, the fastening means may be integral with either the first or second component.

Advantageously, the first component has a slightly curved cross-section, such that when the fastening means is clamping the first and second components together, the fastening means does not project past the first component. Alternatively, the first component may be flexible, such that it is flat when not in use and flexes when the fastening means clamps the first and second components together. The first component is preferably elongate. The first component may be made from metal. The first component may be a plate of steel with an array of apertures. Advantageously, the first component could be a mesh, and more preferably is an expanded metal. The apertures or holes provided in the first component allow the compatible material, such as plaster filler, to fill the depression at the front of the adjacent edges.

The second component is advantageously an elongate channel which forms the recess. Alternatively, the second component is a plate having a cross-section that is a shallow inverted “v”. The second component may be made from steel, aluminium, wood, or any other suitable material.

The first component and the fastening means are preferably dimensioned such that, once clamped, they are seated below the flush front surfaces of the respective panels. According to a second aspect of the invention, there is provided a method for joining adjacent edges of respective panels of sheet material, the method including:
positioning a first component over the front of the adjacent edges;
positioning a second component behind the adjacent edges, the second component having a recess capable of receiving at least a portion of the first component; and
clamping the first and second components together, such that the adjacent edges deform into the recess, whilst simultaneously forming a depression at the front side of the adjacent edges able to be filled with a compatible material to conceal the adjacent edges.

The first and second components may be positioned in any order. The clamping of the first and second components may be by the use of fastening means, such as nails or screws.

In a third aspect of the invention, there is provided a kit for joining adjacent edges of respective panels of sheet material, the kit including:
a first elongate component adapted to be positioned over the front of the adjacent edges; and
a second elongate component adapted to be positioned behind the adjacent edges, the second elongate component having a recess capable of receiving at least a portion of the first component;
wherein, the first and second elongate components are adapted to receive fastening means for clamping the first and second elongate components together in a manner that deforms the adjacent edges into the recess, whilst simultaneously forming a depression at the front side of the adjacent edges able to be filled with a compatible material to conceal the adjacent edges.

Advantageously, the kit includes the fastening means. The fastening means may be a nail or screw or any other suitable means.

Preferably, the first elongate component has a slightly curved cross-section, or is flexible, such that when the first and second components are clamped together, the fastening means does not project past the first component.

The second component preferably consists of a top plate and respective lips at opposite longitudinal edges of the top plate to define the recess. Alternatively, the second component consists of a plate that is slightly bent along a central ridge to form a shallow inverted “v”.

### BRIEF DESCRIPTION OF THE DRAWINGS

The invention will now be described, by way of example only, with reference to the accompanying drawings, in which:

FIG. 1 is a cross-sectional side view of a system for joining adjacent edges of respective panels of sheet material, shown with the fastening means in the unclamped position;

FIG. 2 is a cross-sectional side view of the system of FIG. 1, shown with the fastening means in the clamped position;

FIG. 3 is a cross-sectional perspective view of the system of FIG. 1, without the panels of sheet material;

FIG. 4 is a cross-sectional perspective view similar to FIG. 3 of an alternative system; and

FIG. 5 is a perspective view of the system of FIG. 4 installed.

### DETAILED DESCRIPTION OF THE EMBODIMENTS

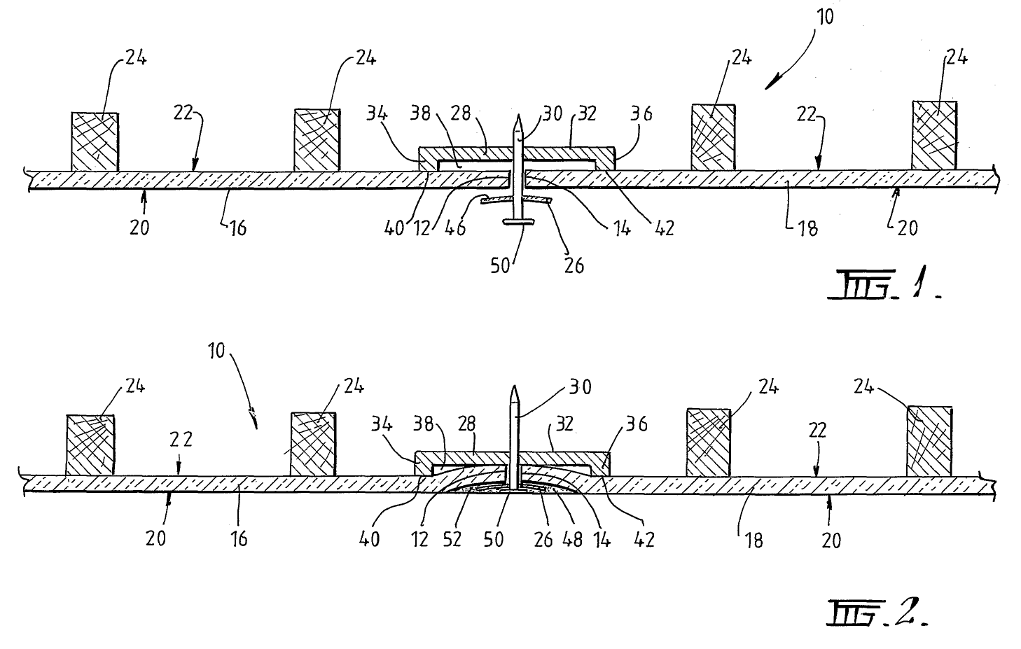

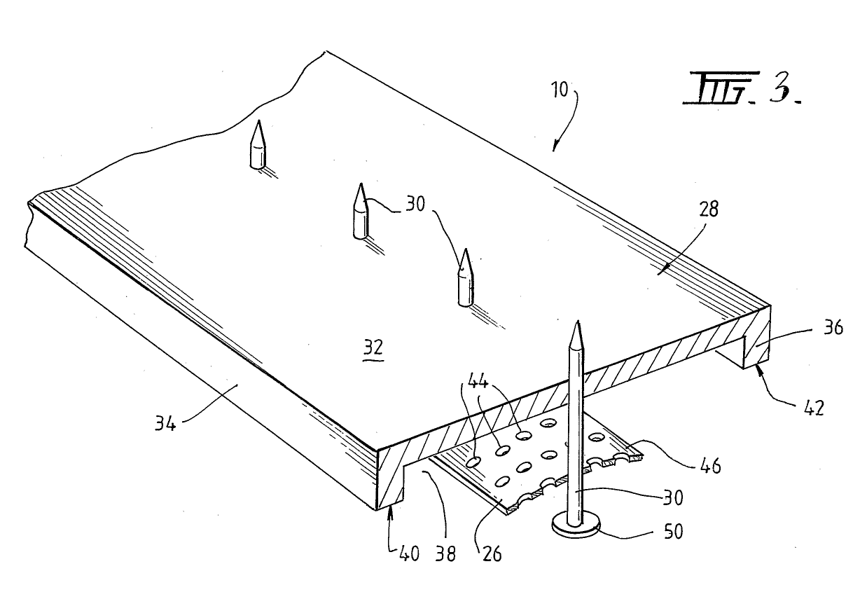

FIGS. 1 and 2 show a system 10 for joining adjacent edges 12, 14 of respective panels 16, 18 of sheet material, such as plaster board. A plurality of panels 16, 18 may be joined together to create a structure such as a ceiling or wall. The panels 16, 18 have a front surface 20 and a back surface 22, with the back surface 22 being positioned against the timber ceiling or wall joists 24.

The system 10 includes a first component 26, a second component 28 and fastening means 30. In the embodiment illustrated, the second component 28 is an integral elongate channel having a top plate 32 and respective lips 34, 36 at the opposite longitudinal edges of plate 32 that define a longitudinally extending recess 38. The second component 28 is positioned behind the adjacent edges 12, 14, such that the bottom surfaces 40, 42 of the lips 34, 36 abut the back surface 22 of the panels 16, 18. The second component 28 will typically run the entire width of the panels 16, 18 and therefore will generally be either 1190 mm or 1340 mm in length. The width of the second component 28 is preferably 200 to 300 mm and the depth of the recess 38 is preferably 50 mm. However, it will be appreciated that the dimensions may differ from those mentioned.

The first component 26 is an elongate transversely curved plate, having an array of apertures 44. The first component 26 may be an expanded metal, or a rigid mesh. The convex side 46 is positioned over the front of the adjacent edges 12, 14. The first component 26 is dimensioned so that at least a portion of it is capable of being received within the recess 38 of the second component 28, by having a width that is smaller than the width of the recess 38.

Fastening means 30 are illustrated as a plurality of nails arranged at intervals longitudinally of the first and second components 26, 28, as shown in FIG. 3. The nails are inserted through the first component 26, between the edges 12, 14 and a hammer is used against the head 50 to force the nail 30 through the second component 28 to clamp the first and second components 26, 28 together.

It will be appreciated that any suitable fastening means may be provided, and that such fastening means may be provided separately or integrally with either the first or second components 26, 28. The fastening means may be provided in the form of a one-way tapered pin on the first component 26, which pin is pushed through and retained in an aperture in the second component 28, locking the two components together.

As can be seen best in FIG. 2, the fastening means 30 is inserted through the first component 26, which is positioned over the front of the adjacent edges 12, 14 and through the second component 28, sitting between the edges 12, 14. As the fastening means 30 clamps the first component 26 towards the second component 28, the edges 12, 14 are deformed into the recess 38, bending about the bottom surfaces 40, 42 of the lips 34, 36. Simultaneously, a depression 48 is formed at the front side of the adjacent edges 12, 14. Due to the curved form of the first component 26, the head 50 of the fastening means 30 does not project past the first component 26. The depression 48 allows the first component 26 and the fastening means 30 to be seated below the flush front surfaces 20 of the panels 16, 18.

As seen in FIGS. 2 and 5, a compatible material 52, such as plaster filler, can be used to fill the depression 48 to conceal the adjacent edges 12, 14, as well as the heads 50 of the fasteners 30. By creating the depression 48, the compatible material 52 can be filled so that it is flush with the front surfaces 20 of the panels 16, 18. The apertures 44 in the first component 26 are provided to allow the compatible material 52 to fill the entire depression 48. This enables the wall or ceiling to be finished in the standard way and the join is concealed.

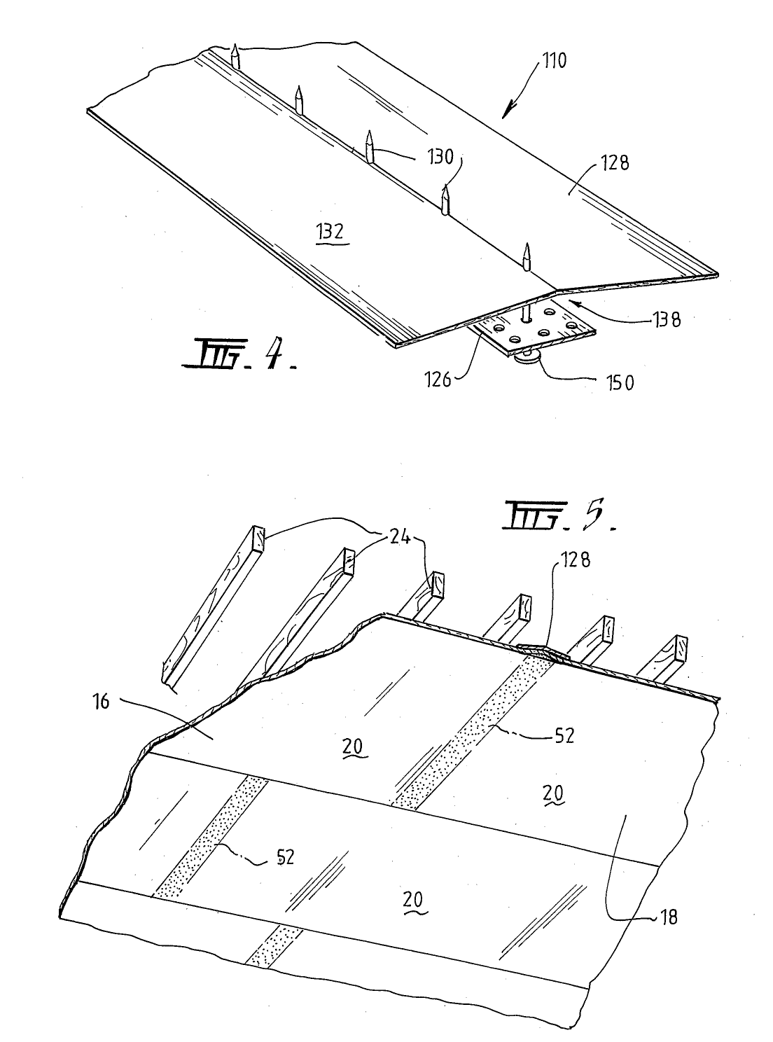

A system 110 including alternative forms of the first and second components 126, 128 is shown in FIG. 4. The first component 126 has a flat cross-section and is made from expanded metal such that it is flexible. When the fastening means 150 clamps the first and second components 126, 128 together, the first component 126 flexes so the fastening means 150 does not project past the first component. The second component 126 is formed from a plate 132 that has a slight bend along a central ridge, such that a shallow inverted “v” is formed. The recess 138 is defined by the space under the inverted “v”.

It will be understood that the invention disclosed and defined in this specification extends to all alternative combinations of two or more of the individual features mentioned or evident from the text or drawings. All of these different combinations constitute various alternative aspects of the invention.

1. A system for joining adjacent edges of respective panels of sheet material, the system including:
a first component adapted to be positioned over the front of the adjacent edges;
a second component adapted to be positioned behind the adjacent edges, the second component having a recess capable of receiving at least a portion of the first component; and
fastening means for clamping the first and second components together in a manner that deforms the adjacent edges into the recess, whilst simultaneously forming a depression at the front of the adjacent edges able to be filled with a compatible material to conceal the adjacent edges.

2. A system according to claim 1, wherein the fastening means is a nail or screw.

3. A system according to claim 1, wherein the fastening means is integral with the first or second component.

4. A system according to claim 1, wherein the first component has a slightly curved cross section, such that when the fastening means is clamping the first and second components together the fastening means does not project past the first component.

5. A system according to claim 1, wherein the first component is flexible, such that when the fastening means is clamping the first and second components together the first component flexes whereby the fastening means does not project past the first component.

6. A system according to claim 5, wherein the first component is elongate.

7. A system according to claim 6, wherein the first component is selected from the group consisting of metal, expanded metal, a plate of steel with an array of apertures, and a mesh.

8. A system according to claim 28, wherein the first component is selected from the group consisting of metal, expanded metal, a plate of steel with an array of apertures, and a mesh.

9. A system according to claim 1, wherein the first component is selected from the group consisting of metal, expanded metal, a plate of steel with an array of apertures, and a mesh.

10. (canceled)

11. A system according to claim 9, wherein the apertures or holes provided in the first component allow the compatible material, such as plaster filler, to fill the depression at the front of the adjacent edges.

12. A system according to claim 1, wherein the second component is an elongate channel which forms the recess.

13. A system according to claim 1, wherein the second component is a plate having a cross section that is a shallow inverted “v.”

14. A system according to claim 13, wherein the second component is made from steel, aluminum or wood.

15. A system according to claim 1, wherein the first component and the fastening means are dimensioned such that, once clamped, they are seated below the flush front surfaces of the respective panels.

16. A method for joining adjacent edges of respective panels of sheet material, the method including:
positioning a first component over the front of the adjacent edges;
positioning a second component behind the adjacent edges, the second component having a recess capable of receiving at least a portion of the first component; and
clamping the first and second components together, such that the adjacent edges deform into the recess, whilst simultaneously forming a depression at the front side of the adjacent edges able to be filled with a compatible material to conceal the adjacent edges.

17. A method according to claim 16, wherein the first and second components are positioned in any order.

18. A kit for joining adjacent edges of respective panels of sheet material, the kit including:
a first elongate component adapted to be positioned over the front of the adjacent edges; and
a second elongate component adapted to be positioned behind the adjacent edges, the second elongate component having a recess capable of receiving at least a portion of the first component;
wherein, the first and second elongate components are adapted to receive fastening means for clamping the first and second elongate components together in a manner that deforms the adjacent edges into the recess, whilst simultaneously forming a depression at the front side of the adjacent edges able to be filled with a compatible material to conceal the adjacent edges.

19. A kit according to claim 18, wherein the kit includes the fastening means.

20. The kit according to claim 19, wherein the fastening means are a nail or screw.

21. A kit according to claim 18, wherein the first elongate component has a slightly curved cross section, such that when the first and second components are clamped together, the fastening means does not project past the first component.

22. A kit according to claim 18, wherein the first component is flexible, such that when the fastening means is clamping the first and second components together the first component flexes whereby the fastening means does not project past the first component.

23. A kit according to claim 18, wherein the second component consists of a top plate and respective lips at opposite longitudinal edges of the top plate to define the recess.

24. A kit according to claim 23, wherein the second component is a plate having a cross section that is a shallow inverted “v.”

25-27. (canceled)

28. A system according to claim 4, wherein the first component is elongate.

29. A system according to claim 7, wherein the apertures or holes provided in the first component allow the compatible material, such as plaster filler, to fill the depression at the front of the adjacent edges.

30. A system according to claim 8, wherein the apertures or holes provided in the first component allow the compatible material, such as plaster filler, to fill the depression at the front of the adjacent edges.

31. A system according to claim 12, wherein the second component is made from steel, aluminium or wood.

32. A system according to claim 6, wherein the second component is an elongate channel which forms the recess.

33. A system according to claim 28, wherein the second component is an elongate channel which forms the recess.

34. A system according to claim 6, wherein the second component is a plate having a cross section that is a shallow inverted “v.”

35. A system according to claim 28, wherein the second component is a plate having a cross section that is a shallow inverted “v.”

36. A kit according to claim 18, wherein the second component is a plate having a cross section that is a shallow inverted “v.”
